(19) United States
(12) Patent Application Publication
(10) Pub. No.: US 2010/0077640 A1
(43) Pub. Date: Apr. 1, 2010

(54) GARMENT TAG AND METHODS OF USE

(76) Inventor: Cathy RANDALL, Beachwood, OH (US)

Correspondence Address: CURATOLO SIDOTI CO., LPA, 24500 CENTER RIDGE ROAD, SUITE 280, CLEVELAND, OH, 44145, US

(21) Appl. No.: 12/239,731

(22) Filed: Sep. 26, 2008

(51) Int. Cl. B42F 21/00; D06L 1/00; D06F 35/00; B23P 6/00

(52) U.S. Cl. 40/360; 8/142; 8/147; 29/402.01

(57) ABSTRACT

A garment tag for organizing a clothing ensemble or wardrobe is disclosed. The garment tag may be associated with a garment or a garment hanger. The garment tag includes a pocket for storing garment accessories to be worn with the particular garment to which the tag is associated and an area for recording information about the garment, such as prior wear or cleaning. The garment tag may include a detachable portion, such as a coupon that may be used for a future garment cleaning.

### TECHNICAL FIELD

The disclosed subject matter relates to a garment tag for organizing and planning a wardrobe. More particularly, the disclosed subject matter relates to a garment tag and method for associating garments and accessories to be worn with the garments.

### BACKGROUND

Personal appearance and image is important in both business and social settings. An individual's style of dress can convey a desirable image and social impression to others. There are many social functions which may be held in regular intervals or time and in which the same people may attend. Being seen in different clothing at different events attended by the same people portrays a sense of personal creativity and fashion. Repeatedly wearing the same clothes to such social functions would inherently create an undesirable notion of thriftiness which may be detrimental to one's personal image. Therefore, it is important to many people to avoid repeatedly wearing the same clothing or accessories to social gatherings attended by the same people.

An individual's style of dress is also important in a business or school setting. Therefore, individual's dressing patterns in a business or school setting should portray the desired sense of fashion, accomplishment and success to clients, potential new clients, co-workers, classmates and others.

One may attempt to avoid repeatedly wearing the same clothing or accessories by having a large and diverse wardrobe. However, purchasing such a large wardrobe is cost prohibitive for many individuals. Furthermore, having a large wardrobe does not prevent an individual from mistakenly wearing certain garments and combinations of garments and accessories on repeated occasions.

### SUMMARY

Provided is a garment tag comprising a body of sheet material, at least one of an opening formed in said body for associating said garment tag with a garment or garment hanger or a pocket for holding at least one item associated with said garment, and an area for recording information regarding said garment. According to certain embodiments, the garment tag includes an opening formed in said body for associating said garment tag with a garment, garment hanger or a pocket for holding at least one item associated with said garment, and an area for recording information regarding said garment.

Also provided is a garment in combination with a garment tag, said garment tag comprising a body of sheet material, at least one of an opening formed in said body for associating said garment tag with a garment or garment hanger or a pocket for holding at least one item associated with said garment, and an area for recording information regarding said garment.

Additionally provided is a method of selling a garment comprising associating a garment tag with said garment, said garment tag comprising a body of sheet material, at least one of an opening formed in said body for associating said garment tag with a garment or garment hanger or a pocket for holding at least one item associated with said garment, and an area for recording information regarding said garment; and selling the garment with the garment tag associated therewith to a buyer.

Further disclosed is a method of cleaning a garment comprising receiving a garment to be cleaned from a garment owner; cleaning said garment; and associating a garment tag with said cleaned garment, said garment tag comprising a body of sheet material, at least one of an opening formed in said body for associating said garment tag with a garment or garment hanger or a pocket for holding at least one item associated with said garment, and an area for recording information regarding said garment.

Further disclosed is a method of storing a garment comprising receiving a garment to be stored from a garment owner, associating a garment tag with said garment, said garment tag comprising a body of sheet material, at least one of an opening formed in said body for associating said garment tag with a garment or garment hanger or a pocket for holding at least one item associated with said garment, and an area for recording information regarding said garment; and storing said garment.

Furthermore disclosed a method of repairing a garment comprising receiving a garment to be repaired from a garment owner, repairing said garment, and associating a garment tag with said repaired garment, said garment tag comprising a body of sheet material, at least one of an opening formed in said body for associating said garment tag with a garment or garment hanger or a pocket for holding at least one item associated with said garment, and an area for recording information regarding said garment.

Further disclosed is a method of organizing a clothing wardrobe comprising associating a garment tag with at least one article of clothing of said wardrobe, said garment tag comprising a body of sheet material, at least one of an opening in said body for associating said garment tag with a garment or garment hanger of a pocket for holding at least one item associated with said garment; and an area for recording information regarding said garment.

### BRIEF DESCRIPTION OF THE DRAWINGS

FIG. 1 shows a view of a first side an illustrative embodiment of the garment tag.

FIG. 2 shows a view of a second side an illustrative embodiment of the garment tag.

FIG. 3 shows a view of the second side of an illustrative embodiment of the garment tag in the closed position.

FIG. 4 shows a view of a first side a further illustrative embodiment of the garment tag.

FIG. 5 shows a view of a second side a further illustrative embodiment of the garment tag.

FIG. 6 shows the garment tag associated with a garment on a hanger.

FIG. 7 shows the garment tag associated with a packaged garment.

### DETAILED DESCRIPTION

Disclosed is a garment tag for use with a garment. The garment tag includes a body of sheet material. The body of the garment tag includes at least one of an opening for engaging the garment tag with a garment or garment hanger or a pocket for holding items associated with the garment, and an area for recording information regarding said garment. According to certain illustrative embodiments, the pocket may further include an opening, such as a slit or slot, that is adapted to accept or otherwise receive a portion of the body of the garment tag to close the pocket.

The material from which the body of the garment tag is prepared may comprise a foldable sheet material. The foldable sheet material may be provided with a perforation or scored line to permit a portion of the body to be folded along the score line into a flap portion that is inserted into the pocket of the garment tag. Alternatively, the pocket may be provided with a slot or opening that is suitable to accept a portion of the garment tag.

Also disclosed is a garment tag in combination with a garment. The garment tag includes a body of sheet material. The body of the garment tag includes at least one of an opening for engaging the garment tag with a garment or garment hanger, a pocket for holding items associated with the garment, and an area for recording information regarding said garment. According to certain illustrative embodiments, the pocket may further include an opening, such as a slit or slot, adapted to accept or otherwise receive a portion of the body of the garment tag to close the pocket. The material from which the body of the garment tag is prepared may comprise a foldable sheet material. The foldable sheet material may be provide with a perforation or scored line to permit a portion of the body to be folded along the score line into a flap portion that is inserted into the pocket of the garment tag. Alternatively, the pocket may be provided with a slot or opening that is suitable to accept a portion of the garment tag.

Additionally disclosed is a method of selling a garment. The method of selling a garment generally includes associating a garment tag with the garment to be sold, said garment tag including a body of sheet material. The term “associated” means that the garment tag may be removably attached directly to a garment, may be removably attached to the garment via an attachment means, may be included within a package containing a garment, or may be attached or engaged with a garment hanger. The body of the garment tag includes at least one of an opening for engaging the garment tag with a garment or garment hanger or a pocket for holding items associated with the garment, and an area for recording information regarding said garment. According to certain illustrative embodiments, the pocket may further include an opening, such as a slit or slot, adapted to accept or otherwise receive a portion of the body of the garment tag to close the pocket. The material from which the body of the garment tag is prepared may comprise a foldable sheet material. The foldable sheet material may be provide with a perforation or scored line to permit a portion of the body to be folded along the score line into a flap portion that is inserted into the pocket of the garment tag. Alternatively, the pocket may be provided with a slot or opening that is suitable to accept a portion of the garment tag.

The garment tag may be associated with a garment in either the folded or unfolded position. For example, when the garment tag used in the unfolded position the tag is associated with a garment by engaging the tag with the garment by attaching the tag to a button or snap though an opening provided in the body of the garment tag. Alternatively, when the garment tag is used in the folded position, the folded garment tag may be inserted into a pocket of the garment to which it is associated.

Further disclosed is a method of cleaning a garment. The method of cleaning the garment includes receiving a garment to be cleaned from a garment owner. The garment is then cleaned, which may comprise either washing the garment or dry cleaning the garment. After the garment has been cleaned, a garment tag is associated with the cleaned garment, and it is returned to the garment owner. Returning the cleaned garment to the garment owner may include either the owner of the garment picking up the cleaned garment from the cleaning facility or the cleaner of the garment or some third party delivering the cleaned garment to the garment owner. The garment tag associated with the cleaned garment generally comprises a body of foldable sheet material, an opening formed in said body for associating said garment tag with a garment or garment hanger, a pocket for holding items associated with said garment, and an area for recording information regarding said garment. The pocket of the garment tag may be used to hold buttons, snaps, or any other part of the garment that may be become separated from the garment during the cleaning process.

Illustrative embodiments of the garment tag will now be described in greater detail with reference to the FIGURES. It should be noted that the garment tag, the garment with associate garment tag and methods of using the garment tag are not intended to be limited to the illustrative embodiments shown in the FIGURES.

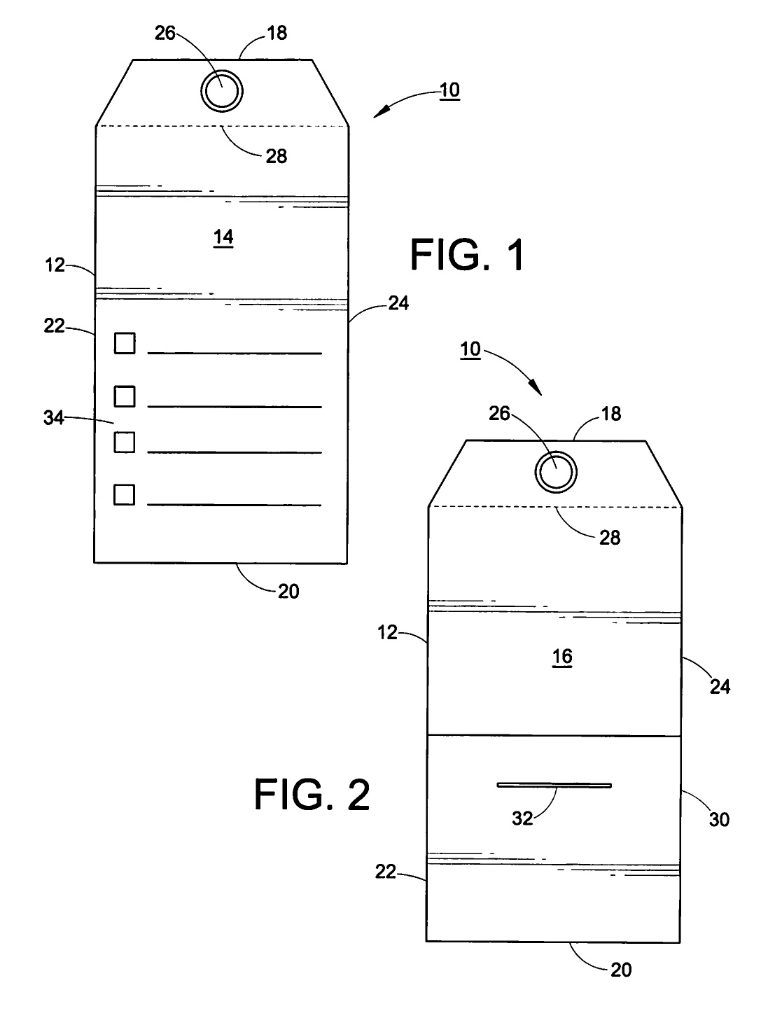

FIGS. 1 and 2 show an illustrative embodiment of the garment tag 10. Garment tag 10 comprises a body 12 of sheet material. Body 12 of garment tag 10 includes a first side 14 and a second side 16. According to the embodiment depicted in FIGS. 1 and 2, body 12 of garment tag 10 is provided in a generally rectangular shape. It should be noted however that body 12 may be provided in variety shapes such as squares, circles, triangles, or any other shape. Body 12 may also be provided in a wide variety of attractive colors.

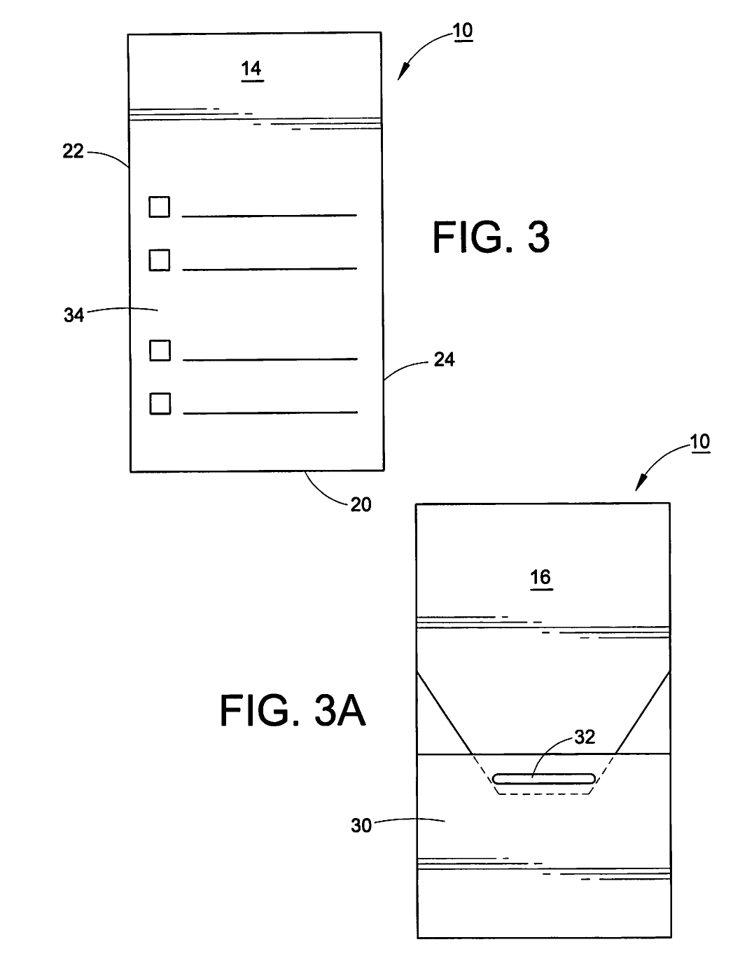

Body 12 of garment tag 10 includes upper and lower ends 18, 20 and opposite lateral sides 22, 24. Upper end 18 of body 12 may be angled or otherwise tapered. An opening 26 may be provided near the upper end 18 of body 12 of the garment tag 10 to permit the garment tag 10 to be attached to a button of a garment or a garment hanger. Body 12 includes fold line 28. Pocket 30 is located on side 16 of body 12 of garment tag 10. Pocket 30 includes opening 32, such as a slit or slot, to receive a portion of upper end 18 of body 12 to close the pocket. As shown in FIG. 3A, in use, body 12 is folded along fold line 28 and a terminal end portion of upper end 18 of body 12 is inserted into slot 32 to close the pocket 30. According to other embodiments, pocket 30 does not include opening 32 and in such embodiments body 12 is folded along fold line 28 and a terminal end portion of upper end 18 of body 12 is simply inserted into pocket 30 to close the pocket.

Referring to FIGS. 1-3, first side 14 includes area 34 that is adapted to receive writing. Writing area 34 may include sub-areas to record information regarding the garment to which garment tag 10 is associated. By way of illustration, but not in limitation, writing area 34 is adapted to receive writing containing information relating to the type and identity of a garment. The information also may include when and where a garment was last worn or history of past wear. The information also may include when and where a garment was purchased. The writing area 34 of garment tag 10 also includes an area to enter information relating to accessories that are to be worn in combination with garment to create a desired clothing ensemble. For example, an owner of a garment may enter in writing area 34 the identity of jewelry pieces, hair clips, scarves, shoes or purses that may be worn with the garment. With respect to a men's garment, information regarding accessories may include type of tie, tie clip, cuff links, or collar stays may be worn with a particular garment. The garment information may also include cleaning instructions, such as whether the garment is to be washed or dry cleaned. If the garment is to be dry cleaned, the information may include the date of the last dry cleaning and the identification of the dry cleaner who cleaned the garment.

Garment tag 10 may be made from paper material, plastic material, or a combination of paper and plastic materials. Garment tag 10 should be prepared from a material that can accept writing thereon with ink or pencil. According to certain illustrative embodiments, garment tag 10 is prepared from a sturdy paper material.

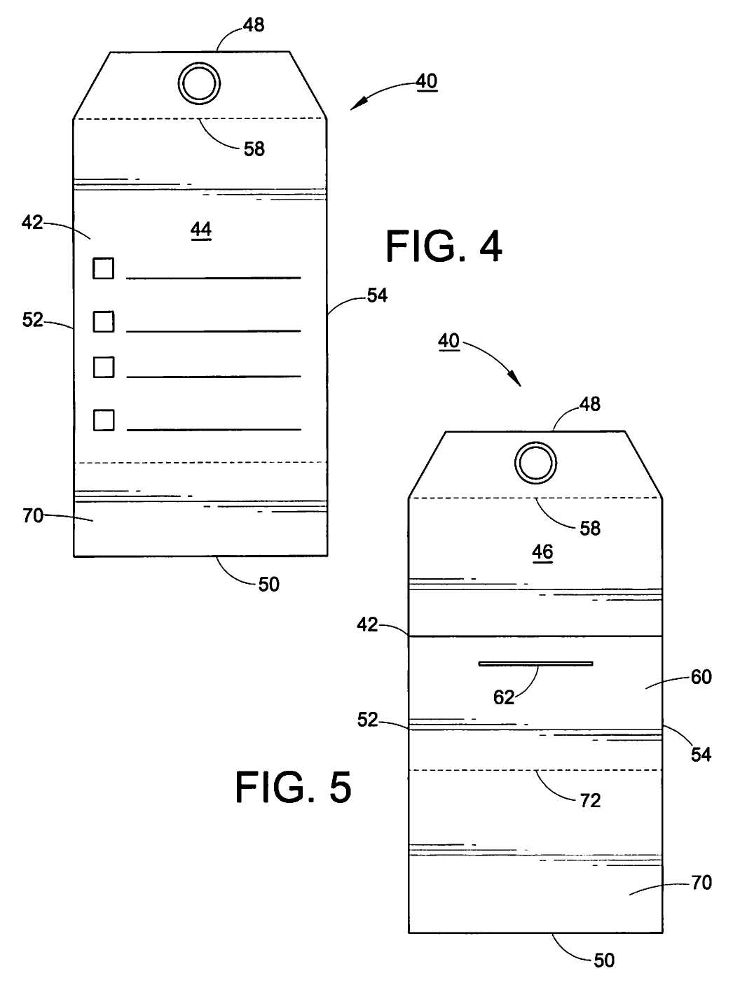

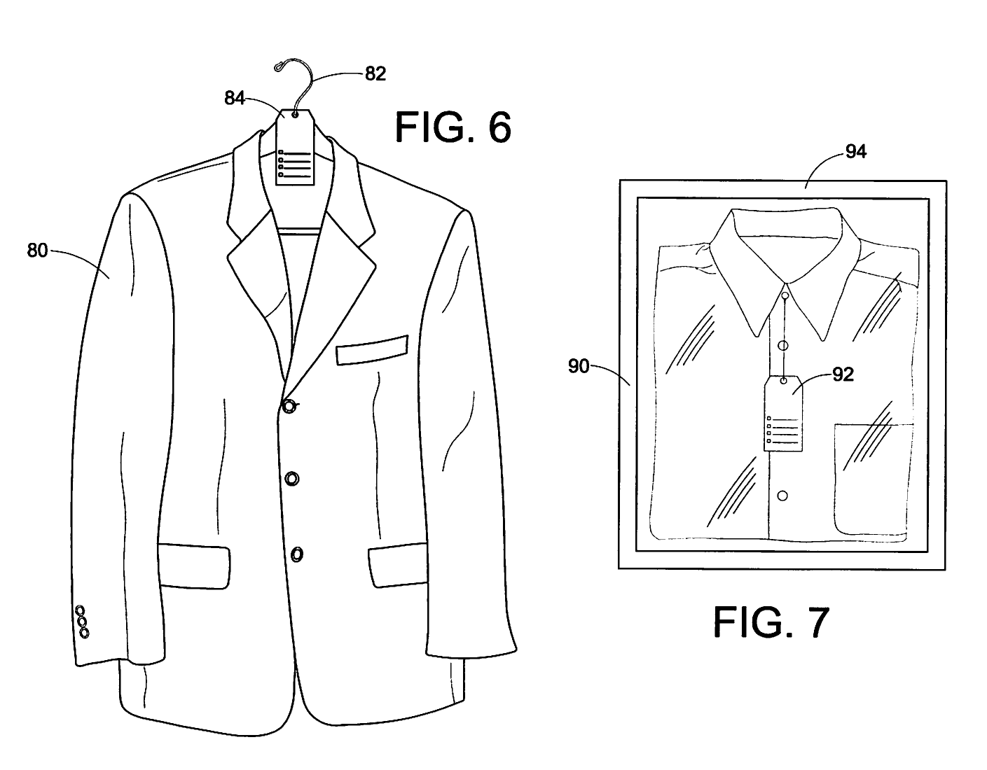

FIGS. 4 and 5 show another illustrative embodiment of the garment tag. Garment tag 40 comprises a body 42 of sheet material. Body 42 of garment tag 40 includes a first side 44 and a second side 46. According to the embodiment depicted in FIGS. 4 and 5, body 42 of garment tag 40 is provided in a generally rectangular shape. Like garment tag 10 shown in FIGS. 1-3, it should be noted that body 42 of garment tag 40 may be provided in other suitable shapes or colors.

Body 42 of garment tag 40 includes upper and lower ends 48, 50 and opposite lateral sides 52, 54. An opening 56 may be provided near the upper end 48 of body 42 of the garment tag 40 to permit the garment tag 40 to be attached to a button of a garment or a garment hanger. Body 52 includes fold line 58. Pocket 60 is located on side 46 of body 42 of garment tag 40. Pocket 60 includes opening 62, such as a slit or slot, to receive a portion of upper end 48 of body 42 to close the pocket. According to FIG. 5, in use, body 42 may be folded along fold line 58 and a terminal end portion of upper end 48 of body 42 is inserted into slot 60 to close the pocket 60. According to other embodiments, pocket 60 does not include opening 62 and in such embodiments body 42 is folded along fold line 58 and a terminal end portion of upper end 48 of body 42 is simply inserted into pocket 60 to close the pocket. According to this illustrative embodiment, garment tag 40 further includes a portion 70 that is detachable from the remainder of body 42. According to certain illustrative embodiments, body 42 is provided with a perforated or scored line 72 to permit easy separation of portion 70 from body 42. According to FIGS. 4 and 5, detachable portion 70 is shown as being detachable from the terminal edge of lower end 50 of body 42. It should be noted that portion 70 may be detachably connected to the upper 48 end or either of the opposing lateral sides 52, 54 of body 42 of garment tag 40. The detachable portion 70 may comprise a coupon for discounts on the cost for future dry cleaning of the garment.

According to FIG. 8, a packaged garment 80 is shown in connection with garment tag 82. The garment 80 with associated garment tag 82 is packaged within package 84. Packaged 84 is shown as a transparent plastic package, but can be any known garment packaging material in the industry. In this particular embodiment, the garment 80 is shown as a men's dress shirt. However, garment tag 82 may be associated with any garment and packaged for sale.

The garment tag may be used in both men's and women's wardrobes to ensure that there is no repetition of clothing worn at functions attended by the same groups of people. For example, the garment tag may be used to avoid repetition of clothing worn to work, school, or social events. The use of the garment tag will permit individuals to keep track of the garments they have worn on different occasions and garment accessories that have been worn with particular garments so that they can appropriately plan the wearing of such garments in the future.

The garment tag may be used in any facility where one party may be responsible for organizing or cleaning another party's wardrobe. For example, and without limitation, the garment tag may be used in a hospital, physical rehabilitation facility, assisted living facility, nursing home, or other long-term care facility, or a day care facility, public school, private school, boarding school, college, university, camp, or other educational institution to organize or clean the wardrobe of a patient, student, or resident. A patient or resident of a hospital or long-term care facility, such as a nursing home, often brings a certain amount of clothing with them to wear during their stay in the facility. The clothing is stored in a closet in the resident's assigned room, or in a common area designated by the facility operator. The resident often needs assistance with dressing and undressing on a daily basis. Furthermore, the care facility is often responsible for cleaning the clothing of its residents. An employee or volunteer working at the care facility assists the residents with these tasks. Because there are a large number of residents living in a long term care facility and there are different workers assigned to a particular resident, it is important that the resident's garment remain associated with the resident and do not become lost or intermingled with the garments of another resident. Furthermore, it is important that any part of a garment that may become separated from the garment during normal wear or cleaning remain associated with the garment.

Loss of dignity and self-esteem are often expressed by residents living in a long term care facility. To maintain a dignified appearance and to avoid embarrassment associated with repeatedly wearing the same garments or combinations of accessories with garments, it is important to organize and track the wardrobe combinations. At the direction of the resident or family member or friend of the resident, a member of the staff of the care facility can ensure that the garment and wardrobe accessories remain associated with a particular garment within the wardrobe. According to illustrative embodiments, the method of organizing a garment wardrobe for a garment owner includes associating a garment tag with at least one garment of within the wardrobe of the patient, resident or student. According to certain embodiments, the garment tag that is associated with the garment of such a patient, resident or student garment tag includes a body of sheet material, an opening in said body for associating said garment tag with a garment or garment hanger, a pocket for holding at least one item associated with said garment, and an area for recording information regarding said garment. The method and device are for identifying and tracking garment and accessories in order to avoid repeating in wearing of the same garment and accessories to the same social function or occasion in its next occurrence. Distinctive identification devices are attachable to the garment and/or accessories after each function and the occasion is recorded either on such identification devices or in an associated recording device such that it can be ascertained that in the next occurrence of the same social function the same garment and accessories would not be worn again.

Further disclosed is a kit comprising a plurality of garment tags 10 or 40 and at least one marking implement for writing information on the garment tags 10 or 40 relating a garment to which the tag 10 or 40 is to be associated. The kit may comprise a package containing a plurality of garment tags 10 or 40 and marking implements for writing information on the garment tags 10 or 40 relating a garment to which the tag 10 or 40 is to be associated. According to certain embodiments, the kit may comprise a flexible transparent package containing a plurality of garment tags 10 or 40 and marking implements for writing information on the garment tags 10 or 40 relating a garment to which the tag 10 or 40 is to be associated. According to other embodiments, the kit may comprise separately packaged garment tags 10 or 40 and marking implements that are sold together as a kit. Furthermore, the separately packaged garment tags and marking implements may be bundled together or placed within an overpack as sold as a kit.

While the garment tag and methods of use have been described in connection with various illustrative embodiments, it is to be understood that other similar embodiments may be used or modifications and additions may be made to the described embodiments for performing the same function disclosed herein without deviating therefrom. The embodiments described above are not necessarily in the alternative, as various embodiments may be combined to provide the desired characteristics. Therefore, the garment tag and methods should not be limited to any single embodiment, but rather construed in breadth and scope in accordance with the recitation of the appended claims.

1. A garment tag comprising:
a body of sheet material;
an opening in said body for associating said garment tag with a garment or garment hanger;
a pocket for holding at least one item associated with said garment; and
an area for recording information regarding said garment.

2. The garment tag of claim 1, wherein said body is made from a paper sheet material.

3. The garment tag of claim 1, wherein said body is made from a plastic sheet material.

4. The garment tag of claim 1, wherein said area for recording information is provided on a first side of said body and wherein said pocket is provided on a second side of said body.

5. The garment tag of claim 1, wherein said second side includes a second area for recording information regarding said garment.

6. The garment tag of claim 1, wherein said area for recording information regarding said garment includes a designated space for recording the identification of said garment.

7. The garment tag of claim 1, wherein said area for recording information regarding said garment includes a designated space for recording the date of purchase of said garment.

8. The garment tag of claim 1, wherein said area for recording information regarding said garment includes a designated space for recording where the garment was purchased.

9. The garment tag of claim 1, wherein said area for recording information regarding said garment includes a designated space for recording where the garment was last worn.

10. The garment tag of claim 1, wherein said area for recording information regarding said garment includes a designated space for recording when the garment was last worn.

11. The garment tag of claim 1, wherein said area for recording information regarding said garment includes a designated space for recording the identity of garment accessories, jewelry, or shoes that are to be worn with said garment.

12. The garment tag of claim 1, wherein said area for recording information regarding said garment includes a designated space for recording how to clean said garment.

13. The garment tag of claim 1, wherein said area for recording information regarding said garment includes a designated space for recording when the garment was last cleaned.

14. The garment tag of claim 1, wherein said area for recording information regarding said garment includes a designated space for recording where the garment was last cleaned.

15. The garment tag of claim 1, wherein said pocket is adapted to hold buttons, snaps, pins, closures, hooks, or any other part of the garment.

16. The garment tag of claim 1, wherein said garment tag further comprises a detachable portion.

17. The garment tag of claim 16, wherein said detachable portion comprises a coupon for a discount on the cost of garment cleaning services.

18. In combination with a garment, a garment tag comprising a body of sheet material; an opening formed in said body for associating said garment tag with a garment or garment hanger; a pocket for holding at least one item associated with said garment; and an area for recording information regarding said garment.

19. A method of selling a garment comprising associating a garment tag with said garment, said garment tag comprising a body of sheet material, an opening formed in said body for associating said garment tag with a garment or garment hanger, a pocket for holding at least one item associated with said garment, and an area for recording information regarding said garment; and selling the garment with the garment tag associated therewith to a buyer.

20. A method of cleaning a garment comprising:
receiving a garment to be cleaned from a garment owner;
cleaning said garment; and
associating a garment tag with said cleaned garment, said garment tag comprising a body of sheet material, an opening formed in said body for associating said garment tag with a garment or garment hanger, a pocket for holding at least one item associated with said garment, and an area for recording information regarding said garment.

21. The method of cleaning a garment of claim 20, comprising dry cleaning said garment.

22. The method of cleaning a garment of claim 20, comprising washing said garment.

23. The method of cleaning a garment of claim 20, further comprising returning said garment to said garment owner.

24. The method of cleaning a garment of claim 20, wherein said garment tag further comprises a detachable portion.

25. The method of cleaning a garment of claim 24, wherein said detachable portion comprises a coupon for a discount on the cost of future garment cleaning services.

26. The method of claim 20, further comprising inserting at least one of a button, snap, pin, hook, closure, or any other part of the garment that may be become separated from the garment during the cleaning process into said pocket of said garment tag.

27. A method of storing a garment comprising:
receiving a garment to be stored from a garment owner;
associating a garment tag with said garment, said garment tag comprising a body of sheet material, an opening formed in said body for associating said garment tag with a garment or garment hanger, a pocket for holding at least one item associated with said garment, and an area for recording information regarding said garment; and
storing said garment.

28. A method of repairing a garment comprising:
receiving a garment to be repaired from a garment owner;
repairing said garment; and
associating a garment tag with said repaired garment, said garment tag comprising a body of sheet material, an opening formed in said body for associating said garment tag with a garment or garment hanger, a pocket for holding at least one item associated with said garment, and an area for recording information regarding said garment.

29. A method of organizing a garment wardrobe for a garment owner comprising associating a garment tag with at least one garment of said wardrobe, said garment tag comprising a body of sheet material, an opening in said body for associating said garment tag with a garment or garment hanger, a pocket for holding at least one item associated with said garment; and an area for recording information regarding said garment.

30. The method of claim 29, wherein said garment owner is a patient or resident in a hospital, physical rehabilitation facility, assisted living facility, nursing home, or other long-term care facility.

31. The method of claim 30, wherein said garment owner is a patient or resident in nursing home.

32. The method of claim 29, wherein said garment owner is a student enrolled in a day care facility, public school, private school, boarding school, college, university, or other educational institution.
